(19) United States
(12) Patent Application Publication
(10) Pub. No.: US 2026/0279326 A1
(43) Pub. Date: Sep. 17, 2026

(54) ACOUSTIC CONTROL DEVICE AND METHOD OF VEHICLE

(71) Applicants: HYUNDAI MOTOR COMPANY, Seoul (KR); KIA CORPORATION, Seoul (KR)

(72) Inventor: Seokhoon RYU, Gyeonggi-do (KR)

(73) Assignees: HYUNDAI MOTOR COMPANY, Seoul (KR); KIA CORPORATION, Seoul (KR)

(21) Appl. No.: 19/306,189

(22) Filed: Aug. 21, 2025

(30) Foreign Application Priority Data
Mar. 11, 2025 (KR) 10-2025-0031173

(51) Int. Cl. G10K 11/178

(52) U.S. Cl. CPC G10K 11/1781; G10K 11/1787

(57) ABSTRACT

An acoustic control device of a vehicle includes a memory, a processor configured to generate a noise cancelling signal for removing noise generated inside the vehicle, a speaker disposed inside the vehicle and outputting the noise cancelling signal according to control of the processor, a microphone disposed inside the vehicle to detect a sound wave signal, and an acceleration sensor disposed in the vehicle to measure a vibration signal, wherein the processor determines a frequency response based on an acoustic transfer path between the speaker, the microphone, and the acceleration sensor and compares the determined frequency response with a normal frequency response stored in the memory and determines whether the acoustic transfer path is abnormal.

### CROSS-REFERENCE TO RELATED APPLICATION

The present application claims priority to and the benefit of Korean Patent Application No. 10-2025-0031173, filed on Mar. 11, 2025, the present disclosure of which is incorporated herein by reference in its entirety.

### BACKGROUND

### Field of the Present Disclosure

Embodiments relate to an acoustic control device and method of a vehicle.

### Discussion of Related Art

In recent years, in the automotive industry, various technologies for reducing interior noise levels in vehicles have been developed. In particular, road noise is generated by contact between a road surface and tires while a vehicle is driving, and the present noise enters a vehicle interior and is pointed out as one of the main causes of the reduction in ride comfort and quietness. In order to solve the present problem, active noise control (ANC) technologies are attracting attention as technologies to reduce noise in vehicles.

Among the ANC technologies for reducing road noise, a road noise reduction (active noise control—road) system utilizes a method of efficiently controlling noise by installing sensors and actuators at specific parts of a vehicle to measure road noise entering the vehicle in real time through a combination of the sensors and actuators and generate noise of an opposite phase to cancel the measured road noise, thereby reducing the level of the interior noise.

However, since the road noise reduction system includes a large number of sensors and actuators, various problems may occur in terms of the reliability and stability of the system. For example, when any of an acceleration sensor, a microphone, or a speaker fails or malfunctions, the control system may become unstable, which may result in a deterioration of the overall noise reduction performance.

Moreover, it is a very difficult task to accurately identify a device in which a problem occurs in a process of analyzing signals collected from a plurality of acceleration sensors, a plurality of microphones, and speakers in real time.

### BRIEF SUMMARY

Therefore, to improve the reliability and stability of the road noise reduction system, it is necessary to develop a technology configured for accurately diagnosing a problematic device when a failure occurs, and through this, a method configured for simultaneously securing the efficiency and stability of the system is required.

Various aspects of the present disclosure are directed to providing an acoustic control device and method of a vehicle configured for rapidly determining a failure of individual devices in a road noise reduction system including a plurality of sensors and actuators.

According to various aspects of the present disclosure, there is provided an acoustic control device of a vehicle including a memory, a processor configured to generate a noise cancelling signal for removing noise generated inside the vehicle, a speaker disposed inside the vehicle and outputting the noise cancelling signal according to control of the processor, a microphone disposed inside the vehicle to detect a sound wave signal, and an acceleration sensor disposed in the vehicle to measure a vibration signal, in which the processor is configured to determine a frequency response based on an acoustic transfer path between the speaker, the microphone, and the acceleration sensor, and compares the determined frequency response with a normal frequency response stored in the memory and determines whether the acoustic transfer path is abnormal.

The memory may store a first normal frequency response determined based on a first acoustic transfer path between the acceleration sensor and the microphone and a second normal frequency response determined based on a second acoustic transfer path between the speaker and the microphone in a state where the speaker, the microphone, and the acceleration sensor normally operate.

The processor is configured to determine a first frequency response based on the first acoustic transfer path, and compare the first frequency response with the first normal frequency response and determine whether the acceleration sensor and the microphone are abnormal.

The memory may store a plurality of first normal frequency responses according to a plurality of first acoustic transfer paths formed by one-to-one matching of a plurality of microphones and a plurality of acceleration sensors.

The processor is configured to determine a plurality of first frequency responses according to the plurality of first acoustic transfer paths and compare the plurality of first frequency responses with the corresponding first normal frequency responses, and determine whether each of the microphones and the plurality of acceleration sensors is abnormal according to a comparison result.

The processor is configured to determine a second frequency response based on the second acoustic transfer path, and compare the second frequency response with the second normal frequency response and determine whether the speaker and the microphone are abnormal.

The memory may store a plurality of second normal frequency responses according to a plurality of second acoustic transfer paths formed by one-to-one matching of a plurality of microphones and a plurality of speakers.

The processor is configured to determine a plurality of second frequency responses according to the plurality of second acoustic transfer paths and compare the plurality of second frequency responses with the corresponding second normal frequency responses, and determine whether each of the microphones and the plurality of speakers is abnormal according to a comparison result.

The processor may compare a magnitude and a phase of the normal frequency response with a magnitude and a phase of the frequency response, respectively, within a preset frequency range and determine a magnitude difference value and a phase difference value.

The processor is configured to determine that there is an abnormality in the acoustic transfer path based on a variance of the magnitude difference value and a variance of the phase difference value are each outside a preset reference range.

According to various aspects of the present disclosure, there is provided an acoustic control method of a vehicle which is performed by a computing device including one or more processors and a memory storing one or more programs executed by the one or more processors, including determining, by the processor, a frequency response based on an acoustic transfer path between a speaker, a microphone, and an acceleration sensor of a vehicle, comparing, by the processor, the determined frequency response with a normal frequency response stored in the memory, and determining, by the processor, whether the acoustic transfer path is abnormal according to a result of comparing the determined frequency response with the normal frequency response.

The memory may store a first normal frequency response determined based on a first acoustic transfer path between the acceleration sensor and the microphone and a second normal frequency response determined based on a second acoustic transfer path between the speaker and the microphone in a state where the speaker, the microphone, and the acceleration sensor normally operate.

The determining of whether the acoustic transfer path is abnormal may include determining a first frequency response based on the first acoustic transfer path and comparing the first frequency response with the first normal frequency response and determining whether the acceleration sensor and the microphone are abnormal.

The memory may store a plurality of first normal frequency responses according to a plurality of first acoustic transfer paths formed by one-to-one matching of a plurality of microphones and a plurality of acceleration sensors.

The determining of whether the acoustic transfer path is abnormal may include determining a plurality of first frequency responses according to the plurality of first acoustic transfer paths and comparing the plurality of second frequency responses with the corresponding first normal frequency responses, and determining whether each of the microphones and the plurality of acceleration sensors is abnormal according to a comparison result.

The determining of whether the acoustic transfer path is abnormal may include determining a second frequency response based on the second acoustic transfer path, and comparing the second frequency response with the second normal frequency response and determining whether the speaker and the microphone are abnormal.

The memory may store a plurality of second normal frequency responses according to a plurality of second acoustic transfer paths formed by one-to-one matching of a plurality of microphones and a plurality of speakers.

The determining of whether the acoustic transfer path is abnormal may include determining a plurality of second frequency responses according to the plurality of second acoustic transfer paths and comparing the plurality of second frequency responses with the corresponding second normal frequency responses, and determining whether each of the microphones and the plurality of speakers is abnormal according to a comparison result.

The determining of whether the acoustic transfer path is abnormal may include comparing a magnitude and a phase of the normal frequency response with a magnitude and a phase of the frequency response, respectively, within a preset frequency range and determining a magnitude difference value and a phase difference value.

In the determining of whether the acoustic transfer path is abnormal, it may be determined that there is an abnormality in the acoustic transfer path based on a variance of the magnitude difference value and a variance of the phase difference value are each outside a preset reference range.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view showing a vehicle transmitting and receiving data by communicating with other devices;

FIG. 2 is a diagram showing modules forming a vehicle according to an exemplary embodiment of the present disclosure;

FIG. 3 is a block diagram of an acoustic control device of a vehicle according to an exemplary embodiment of the present disclosure;

FIG. 4 and FIG. 5 are views for describing a noise control algorithm of a processor according to the embodiment;

FIG. 6 and FIG. 7 are views for describing the operation of determining whether the processor is abnormal according to the embodiment; and

FIG. 8 is a flowchart of an acoustic control method of a vehicle according to an exemplary embodiment of the present disclosure.

### DETAILED DESCRIPTION OF EXEMPLARY EMBODIMENTS

Hereinafter, exemplary embodiments of the present disclosure will be described in detail with reference to the accompanying drawings.

However, the technical idea of the present disclosure is not limited to various exemplary embodiments to be described but may be implemented in various different forms, and within the scope of the technical idea of the present disclosure, one or more among components in the exemplary embodiments of the present disclosure may be used by being selectively combined and substituted.

Furthermore, unless specifically defined and described, terms used in the exemplary embodiments of the present disclosure (including technical and scientific terms) may be interpreted as meanings which are generally understood by those skilled in the art to which an exemplary embodiment of the present disclosure pertains, and commonly used terms such as terms defined in dictionaries may be interpreted in consideration of the contextual meaning of the related art.

The terms used in the exemplary embodiments of the present disclosure are for describing the exemplary embodiments only and are not intended to limit the present disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, when describing components of embodiments of the present disclosure, terms such as first, second, A, B, (a), (b), etc., may be used.

These terms are only for distinguishing the components from other components, and the essence, sequence, or order of the components is not limited by these terms.

In addition, when a component is referred to as being “linked,” “coupled,” or “connected” to another component, the component is not only directly linked, coupled, or connected to another component, but also “linked,” “coupled,” or “connected” to another component with yet another component disposed between the component and the other component.

Furthermore, when a component is referred to as being formed or disposed “on (above) or under (below)” another component, the term “on (above) or under (below)” includes not only when two components are in direct contact with each other, but also when one or more other components are formed or disposed between the two components. Furthermore, when a component is referred to as being “on (above) or below (under),” the description may include the meanings of an upward direction and a downward direction based on one component.

Hereinafter, embodiments will be described in detail with reference to the accompanying drawings, but the same or corresponding components are denoted by the same reference numerals regardless of the drawing numbers, and redundant descriptions thereof will be omitted.

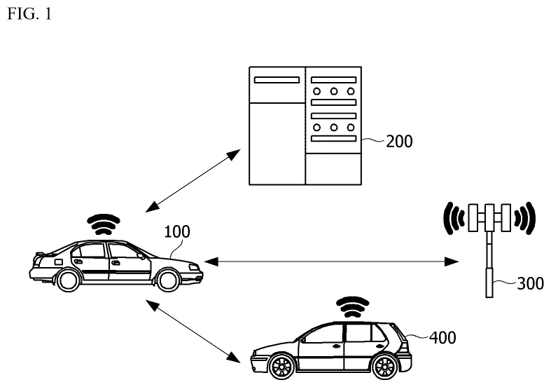

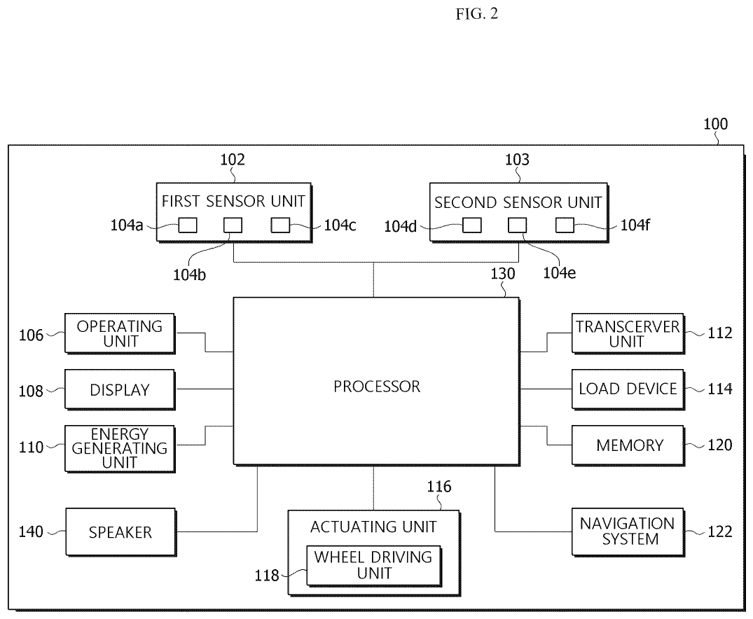

Hereinafter, a vehicle will be described with reference to FIG. 1 and FIG. 2. FIG. 1 is a view exemplarily illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. Furthermore, the fuel cell may use various types of gas capable of generating electrical energy, and the vehicle 100 may be filled with gas in a liquefied state, for example. Here, one example of the gas may be hydrogen. However, the gas is not limited thereto, and various gases are applicable. In the case of fossil energy, the vehicle 100 is driven based on fuel such as gasoline, diesel or liquefied gas, and may be provided with an internal combustion engine that drives an actuating unit 116 by combustion of the fuel. The engine may be included in an energy generating unit 110 in terms of providing a driving rotation force of wheels to a wheel driving unit 118. As an exemplary embodiment of the present disclosure, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger vehicle, a commercial vehicle, a purpose-built vehicle (PBV), or the like. The vehicle 100 may be a four-wheeled vehicle, such as a passenger vehicle, a sports utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may be moved using wheels, tracks, or other movement modules. In an exemplary embodiment of the present disclosure, ground mobility devices such as ground vehicles are mainly described, but unless it contradicts the present disclosure, the exemplary embodiment of the present disclosure may also be applied to air mobility devices such as an advance air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be disposed as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or disposed to service autonomous driving, and may receive connected data of the vehicle 100 or transmit data necessary for autonomous driving. The server 200 may transmit various information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her host vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules forming a vehicle according to an exemplary embodiment of the present disclosure.

The vehicle 100 may include a sensor unit 102, an operating unit 106, a display 108, a load device 114, and a transcerver unit 112.

The sensor unit 102 may be provided with various types of detectors to detect various states and situations occurring in an external environment, an internal system, user operation, and a boarding space of the vehicle 100.

The first sensor unit 102 may be disposed with an externally oriented camera 104a, a Light Detection and Ranging (LiDAR) sensor 104b, a radio detection and ranging (RADAR) sensor 104c, and the like, to recognize dynamic and static objects present outside the vehicle 100. The camera 104a may recognize an external object as an image while the vehicle 100 is in use, generate image data, and transmit the image data to the processor 130. The LiDAR sensor 104b may be configured to generate point cloud data as recognized data of the external object and transmit the point cloud data to the processor 130 to generate 3D spatial information that identifies at least a shape of the external object. To ascertain the presence of an external object and its relative distance, speed, direction, or the like, the radar sensor 104c may emit radio waves of a specific frequency around the vehicle 100 and generate radar data through radio waves reflected from the external object. In an exemplary embodiment of the present disclosure, the sensor unit is illustrated as having the LiDAR sensor 104b, but in other examples, the LiDAR sensor 104b may not be mounted.

The first sensor unit 102 may be configured to generate object recognition information based on detecting data. The object recognition information may include information on the presence of an object, position information related to the object, information on a distance between the vehicle 100 and the object, and information on a relative speed between the vehicle 100 and the object. In the exemplary embodiment of the present disclosure, external objects may be various objects related to the operation of the vehicle 100.

A second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be provided with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may be configured to generate vehicle driving information based on detecting data. The vehicle driving information may be information generated based on data detected by various sensors disposed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, engine temperature information, and the like.

Furthermore, the vehicle driving information may include path information. The path information may refer to information generated based on a destination input by a vehicle user through the operating unit 106. The path information may refer to information that indicates a traveling path from a current position of a host vehicle to a destination on a map when the destination has been set. When no destination is set, the path information may refer to information including a road on which the host vehicle is currently traveling and a future driving path including the road.

The operating unit 106 may be configured as a module which is controlled by the user for driving. For example, the operating unit 106 may be a steering wheel for manual driving, an automatic or manual shift transmission, an accelerator pedal, a brake pedal, or the like. The operating unit 106 may be further disposed with an interface for enabling or disabling an autonomous driving mode and selecting detailed functions requested by the user so that the user may use an autonomous driving function. To receive various requests related to autonomous driving, the operating unit 106 may be configured, for example, as a hard-type interface disposed at a predetermined position inside the vehicle 100, or as a soft-type interface which may be touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, path/traffic information, remaining energy amount information, content requested by the driver, or the like, of the vehicle 100 by the processor 130. Furthermore, the display 108 may be configured as a touch screen configured for detecting a driver's input to receive a driver's request to instruct the processor 130.

The load device 114 is disposed on the vehicle 100 and may be a type of non-driving electrical device excluding a driving power system such as the wheel driving unit 118 or the like. The load device 114 is an auxiliary device that receives electric power from the energy generating unit 110, and may be, for example, an air conditioning system, a lighting system, a seat system, various devices disposed in the vehicle 100, or the like. In an exemplary embodiment of the present disclosure, a cooling/heating system that cools or heats at least one of a battery, a fuel cell, an internal combustion engine, an air conditioning system, and a specific part of the vehicle 100 may be further included.

The transcerver unit 112 may support mutual communication with the server 200, the ITS device 300, nearby vehicles 400, and the like. The transcerver unit 112 may include a module that processes, for example, cellular communication, WAVE, DSRC communication, and the like. In an exemplary embodiment of the present disclosure, the transcerver unit 112 may transmit data generated or stored while driving to the server 200 and receive data and software modules transmitted from the server 200. The transcerver unit 112 may support communication with an electronic device carried by an occupant inside the vehicle 100. In an exemplary embodiment of the present disclosure, the vehicle 100 may transmit and receive data utilized in a method according to an exemplary embodiment of the present disclosure to or from the outside through the transcerver unit 112.

For example, the transcerver unit 112 may receive traffic signal information from a traffic signal controller and provide the traffic signal information to the processor 130. Furthermore, the transcerver unit 112 may receive a control signal from the traffic signal controller and provide the control signal to the processor 130.

Furthermore, the vehicle 100 may include the energy generating unit 110 and the actuating unit 116.

The energy generating unit 110 may be configured to generate and supply power and electric power used in a driving power system and a non-driving power system, such as the actuating unit 116. The non-driving power system may be, for example, the sensor unit 102, the operating unit 106, the display 108, the load device 114, and the transcerver unit 112, but is not limited thereto, and may include various components that implement detecting, interface, communication, and convenience functions, excluding components directly involved in driving operations. When the vehicle 100 is driven based on electrical energy, the energy generating unit 110 may be configured as an electric battery charged from the outside thereof, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. Furthermore, when the vehicle 100 is a hybrid type, the energy generating unit 110 may be disposed as a combination of the internal combustion engine and the electric battery.

The actuating unit 116 may be disposed with at least one module that implements driving operations and perform at least one driving operation among longitudinal control such as acceleration and deceleration and lateral control such as steering, according to a user request from the operating unit 106. To perform driving operations according to a command of the processor 130 by manual operation of the user or autonomous driving, the actuating unit 116 may be disposed with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be disposed with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further include a regenerative braking function.

A navigation system 122 may provide navigation information. The navigation information may include at least one of map information, set destination information, path information according to a set destination, information on various objects on the path, lane information, and current vehicle position information.

The navigation system 122 may receive information from an external device through the transcerver unit 112 and update previously stored information. According to the exemplary embodiment of the present disclosure, the navigation system 122 may be classified as a sub-component of the operating unit 106.

A speaker 140 may convert an electrical signal provided from the processor 130 into an audio signal and output the audio signal. To the present end, the speaker 140 may include one or more speakers.

Furthermore, the vehicle 100 may include a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

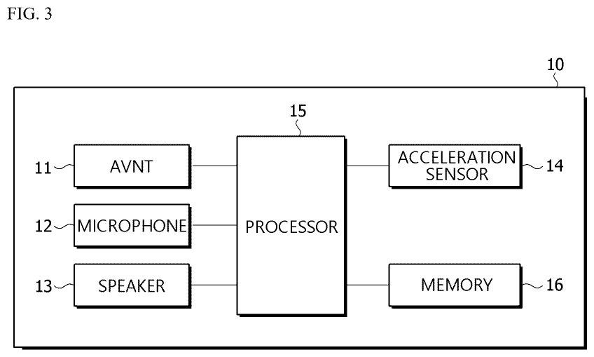

FIG. 3 is a block diagram of an acoustic control device of a vehicle according to an exemplary embodiment of the present disclosure. Referring to FIG. 3, an acoustic control device 10 of a vehicle according to the exemplary embodiment of the present disclosure may include an AVNT 11, a microphone 12, a speaker 13, an acceleration sensor 14, a processor 15, and a memory 16.

Furthermore, the acoustic control device 10 of the vehicle may further include an amplifier (AMP) for audio reproduction.

In the exemplary embodiment of the present disclosure, the processor 15 may refer to the same configuration as the processor of FIG. 2, and the memory 16 may refer to the same configuration as the memory of FIG. 2.

The AVNT 11 is a term referring to an information and entertainment system in the vehicle, and may refer to a system that integrates navigation, audio, video, and communication functions. The AVNT 11 may output a message generated by the processor 15 in at least one of a visual manner, an audible manner, or a combination thereof.

The AVNT 11 may refer to a component that provides a hardware interface integrated into the system in the vehicle. The AVNT 11 may perform system control targeting screens, buttons and various integrated information and entertainment functions.

The AVNT 11 is disposed in a center or console of the vehicle dashboard and may provide vehicle information and an entertainment interface. The information and entertainment system may include AM/FM radio, satellite radio, DVDs/CDs, cassette tapes, USB MP3, dashcams, Global Positioning System (GPS) navigation, Bluetooth, Wi-Fi, and the like, and may also provide state information on the vehicle system. Furthermore, the AVNT 11 may perform functions such as speech control, motion recognition, and the like.

The AVNT 11 may include a microphone 12, the speaker 13, and the processor 15, but for convenience of description, each configuration will be separately described.

The microphone 12 is disposed inside the vehicle and may detect sound wave signals including voice signals and road noise signals.

In the exemplary embodiment of the present disclosure, the voice signal may refer to an acoustic signal generated by utterance of a vehicle occupant.

In the exemplary embodiment of the present disclosure, the road noise signal may refer to ambient noise generated due to the interaction between the road and tires during vehicle traveling, a surrounding environment, and the structural characteristics of the vehicle itself. The road noise signal may include tire-to-road surface contact noise, aerodynamic noise, engine and exhaust system noise, and structural vibration noise of the vehicle.

The microphone 12 may be disposed inside the vehicle, and may receive the voice signal and the road noise signal that are detected inside the vehicle. The microphone 12 may be disposed in various positions inside the vehicle to receive these acoustic signals as clearly as possible.

Furthermore, the microphone 12 may receive a noise cancelling signal output from the speaker 13.

For example, the microphone 12 may be disposed in a headliner portion of the vehicle. The position may be close to the mouth of the occupant to receive speech efficiently and receive relatively less ambient noise (e.g., wind noise coming in through the window).

For example, the microphone 12 may be disposed on or adjacent to a rearview mirror to collect the speech of the occupant.

For example, the microphone 12 may be disposed by being integrated into the AVNT 11 of the dashboard.

For the microphone 12, a single microphone, dual microphones, or a plurality of microphones may be applied.

The single microphone may receive the speech of the driver using only one microphone in the vehicle.

The dual microphones may provide better noise suppression and echo cancellation performance by use of two microphones. The dual microphones may be used so that one microphone may collect speech of the occupant and the other may collect ambient noise, and then compare the speeches and the noise to remove the noise and extract the speech.

The multiple microphones may use a multiple microphone array to enhance the directionality of sound and selectively receive only the speech coming from a specific direction through beamforming technology.

Furthermore, the microphone 12 may be disposed inside the vehicle, especially near a head or ear position of an occupant, to measure the noise actually heard by the occupant. The microphone 12 may detect residual noise introduced into the vehicle to monitor levels of various noises including road noise, engine noise, wind noise, and the like. That is, when the noise cancelling signal is output into the vehicle interior for noise cancellation, the microphone 12 may measure the residual noise remaining inside the vehicle in an environment where the vehicle interior noise is removed by the noise cancelling signal. The residual noise may be measured as an error signal or a residual signal by a microphone 12. The error signal may be used as information to determine whether the noise inside the vehicle is normally reduced or eliminated.

When the noise cancelling signal (anti-noise) is output through the speaker 13 in the processor 15, the microphone 12 may check how effectively the present signal works inside the vehicle. In the exemplary embodiment of the present disclosure, the noise cancelling signal may have an amplitude equal to the amplitude of the noise inside the vehicle, but a phase opposite to the phase of the noise.

The speaker 13 may convert an electrical signal provided from the processor 15 into an audio signal and output the audio signal. To the present end, the speaker 13 may include one or more speakers.

For example, the speaker 13 may convert the noise cancelling signal determined through the processor 15 into an audio signal and output the audio signal.

The speaker 13 may be strategically disposed to provide an optimal sound effect. For example, the speaker 13 may be disposed on a dashboard, an A-pillar, a door panel, a rear deck, a headrest, a seat, and the like.

When the acoustic control device of the vehicle includes the AMP, the AMP may receive a noise cancelling signal from the processor, receive an audio signal from an AVNT device, mix the noise cancelling signal and the audio signal, and output a mixed signal through the speaker 13.

The AMP may adjust the amplitude of the mixed signal using amplifiers. The amplifiers may include vacuum tubes, transistors, or the like for amplifying the power of the mixed signal.

The speaker 13 may receive the mixed signal, which is an electrical signal, from the AMP or a noise cancelling signal from a processor, and output the mixed signal or noise cancelling signal into the vehicle in the form of sound waves. The noise inside the vehicle may be reduced or eliminated by the mixed output of the speaker 13. In particular, the noise may be maximally reduced at the microphone or at an ear position of an occupant.

The speaker 13 may output the noise cancelling signal primarily to a specific occupant. The speaker 13 may cause reinforcing interference or cancelling interference at the ear position of the specific occupant by differently outputting the phase of the noise cancelling signal at a plurality of positions within the vehicle.

The acceleration sensor 14 may be disposed in the vehicle to measure a vibration signal.

The acceleration sensor 14 may detect vibration occurring in a vehicle body, an engine mount, a suspension system, and the like, of the vehicle. The acceleration sensor 14 may be configured to generate reference signals according to the vibration of the vehicle, and the reference signals may refer to acceleration signals. The acceleration sensor 14 is a three-axis accelerometer which may measure vibration along three vertical axes.

For example, the acceleration sensor 14 may be disposed around the engine mount of the vehicle to monitor the vibration generated from the engine in real time.

For example, the acceleration sensor 14 may be disposed on a vehicle body frame and a sub-frame to detect contact vibration between the tire and the road.

For example, the acceleration sensor 14 may be disposed on a floor of the vehicle to monitor the vibration transmitted to the entire vehicle body.

For example, the acceleration sensor 14 may be disposed in a trunk and a rear sub-frame to detect the vibration occurring at the rear of the vehicle.

For example, the acceleration sensor 14 may be disposed in an A-pillar, B-pillar, and the like, to monitor structural vibration of the entire vehicle.

In the exemplary embodiment of the present disclosure, at least one acceleration sensor 14 may be disposed according to a vehicle model, size, and design structure to detect vibrations occurring in various regions of the vehicle and generate the vibration signal.

In the exemplary embodiment of the present disclosure, the acceleration sensor 14 may be configured to generate a reference signal representing vibration caused by friction between wheels of the vehicle and a road surface, and transmit the reference signal to the processor 15. In the instant case, the acceleration sensor 14 may transmit the reference signal in a form of an analog signal to the processor 15. Alternatively, the acceleration sensor 14 may convert the reference signal into a digital signal and transmit the converted digital signal to the processor 15.

The processor 15 may be configured to generate a noise cancelling signal to remove noise generated inside the vehicle. The processor 15 may be configured to generate the noise cancelling signal to remove noise inside the vehicle based on the reference signal and an error signal of the acceleration sensor 14. The processor 15 may be configured to generate a noise cancelling signal including an amplitude equal to the amplitude of the noise signal but a phase opposite to the phase of the noise signal. The processor 15 may convert the reference signal and the error signal, which are analog signals, into digital signals and generate the noise cancelling signal from the converted digital signals.

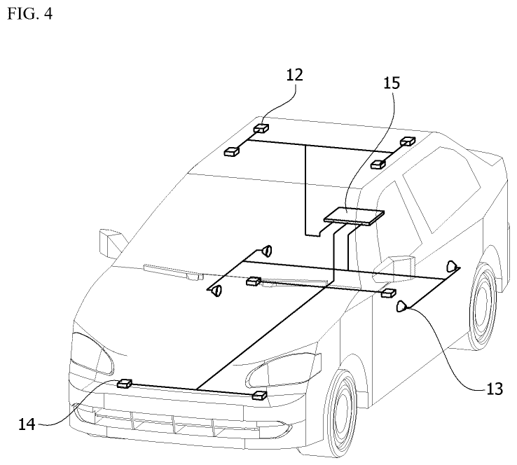

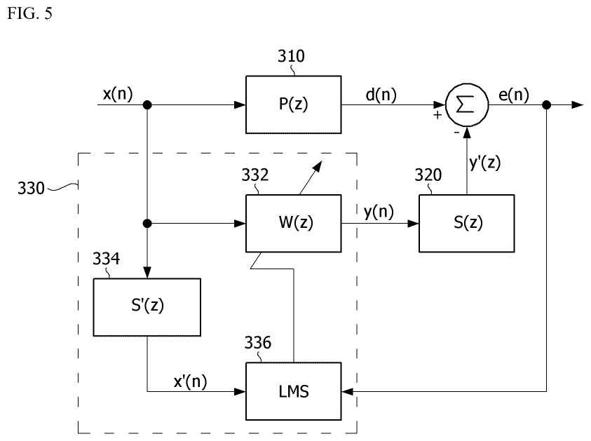

FIG. 4 and FIG. 5 are views for describing a noise control algorithm of a processor according to the exemplary embodiment of the present disclosure. Referring to FIG. 4 and FIG. 5 together, a primary path 310, a secondary path 320, a processor 330, an adaptive filter 332, a secondary path model 334, and an adaptive filter controller 336 are illustrated.

The noise control algorithm illustrated in FIG. 4 and FIG. 5 relates to a single-channel feedforward FxLMS algorithm. In the exemplary embodiment of the present disclosure, multi-channel structures including many additional channels, many additional microphones, and many additional speakers may also be employed. For example, 3 acceleration sensors may be disposed around each vehicle wheel, and 8 microphones may be disposed along a headliner inside the vehicle. Furthermore, 5 speakers may be disposed along a center fascia of the vehicle and doors of each seat. Accordingly, a plurality of acoustic transfer path models and adaptive filters may be used.

A reference signal x(n) is detected by the acceleration sensor. For example, the reference signal x(n) may be a measurement signal of the acceleration sensor. The reference signal x(n) becomes a noise signal d(n) through the primary path 310. Each acceleration sensor may measure vibration along three vertical axes and generate three reference signals. Therefore, the reference signals measured by the four acceleration sensors may be composed of 12 signals.

The primary path 310 represents an acoustic transfer path between the acceleration sensor and the microphone. Acoustic transfer characteristics P(z) of the primary path 310 may be derived from a relationship between the reference signal x(n) and the noise signal d(n). For example, a transfer function of the primary path 310 may be determined from frequency response functions of the reference signal x(n) and the noise signal d(n). As the acoustic transfer characteristics of the primary path 310, “d(n)/x(n)” may be used. In the exemplary embodiment of the present disclosure, the acoustic transfer characteristics may be used as the same meaning as the transfer function.

The noise signal d(n) is the noise at a position that the processor 330 desires to control. For example, the noise signal d(n) represents the noise at the ear position of the occupant or the noise at the position of the microphone. Here, the position of the microphone may be approximated to the ear position of the occupant, which is a noise control point.

The processor 330 generates a noise cancelling signal y(n) using the reference signal x(n) and an error signal e(n) to remove the noise signal d(n). The noise cancelling signal y(n) is a signal for removing or attenuating the noise signal d(n).

The processor 330 may be configured to generate the noise cancelling signal y(n) using an adaptive control algorithm. For example, the processor 330 may use various algorithms such as filtered-input least mean square (FxLMS), filtered-input normalized least mean square (FxNLMS), filtered-input recursive least square (FxRLS), filtered-input normalized recursive least square (FxNRLS), or the like.

The processor 330 may use the adaptive filter 332, the secondary path model 334, and the adaptive filter controller 336 to generate the noise cancelling signal y(n).

The adaptive filter 332 receives the reference signal x(n) and generates the noise cancelling signal y(n) for controlling the noise signal d(n). The transfer function of the adaptive filter 332 may be expressed as W(z), and the transfer function W(z) of the adaptive filter 332 may represent at least one filter coefficient. Here, the filter coefficients may form a filter coefficient set in units of 256, and may form a plurality of filter coefficient sets. The adaptive filter 332 may include a set of 96 filter coefficients, which are multiplication values between 12 reference signals and 8 speakers. The noise cancelling signal y(n) may be derived by a convolution operation between the reference signal x(n) and the transfer function W(z) of the adaptive filter 332.

The filter coefficients of the adaptive filter 332 are determined and updated by the adaptive filter controller 336. The adaptive filter controller 336 updates the filter coefficients by considering that the noise cancelling signal y(n) is transformed by the secondary path 320 after being output from the speaker. Here, the secondary path 320 is an acoustic transfer path between the speaker and the microphone.

A transfer function S′(z) of the secondary path model 334 representing acoustic transfer characteristics for the secondary path 320 may be estimated in advance. For example, in a noise-free situation inside the vehicle, the secondary path model 334 may be estimated from the output of the speaker and the input of the microphone. In addition to the modeling method described above, the secondary path 320 may be modeled by an appropriate method by a person skilled in the art among methods for modeling to best describe the physical phenomenon of an actual audio system.

The adaptive filter controller 336 receives a reference signal x′(n) obtained by filtering the reference signal x(n) by the secondary path model 334 and the error signal e(n) of the microphone. Here, the error signal e(n) is a signal measured for a residual noise that remains after the noise signal d(n) is canceled by the noise cancelling signal y(n) at a noise control point, such as the position of the microphone.

The adaptive filter controller 336 updates the filter coefficients of the adaptive filter 332 by applying a least mean square (LMS) algorithm to the filtered reference signal x′(n) and the error signal e(n). The filter coefficients W(z) may be updated by gradient descent.

The updated adaptive filter 332 generates the noise cancelling signal y(n) from the reference signal x(n). After updating the adaptive filter 332, the adaptive filter 332 generates the noise cancelling signal y(n) so that the noise cancelling signal y′(n) transformed by the secondary path 320 has the same amplitude and opposite phase as the noise signal d(n). In other words, the noise cancelling signal y(n) generated by the updated adaptive filter 332 has the same amplitude and opposite phase as d(n) at the position of the microphone when passing through the secondary path 320.

Therefore, the error signal e(n) measured by the position of the microphone is minimized.

Through the present process, even when at least one of the reference signal x(n), the noise signal d(n), or the secondary path 320 changes, the processor 330 may adaptively generate the noise cancelling signal y(n).

The memory 16 may store a first normal frequency response determined based on a first acoustic transfer path between the acceleration sensor 14 and the microphone 12 and a second normal frequency response determined based on a second acoustic transfer path between the speaker 13 and the microphone 12 in a state where the speaker 13, the microphone 12, and the acceleration sensor 14 normally operate.

The memory 16 may store a plurality of first normal frequency responses according to a plurality of first acoustic transfer paths formed by one-to-one matching of a plurality of microphones 12 and a plurality of acceleration sensors 14.

Furthermore, the memory 16 may store a plurality of second normal frequency responses according to a plurality of second acoustic transfer paths formed by one-to-one matching of the plurality of microphones 12 and the plurality of speaker 13.

Furthermore, the processor 15 may be configured to determine a frequency response based on the acoustic transfer path between the speaker 13, the microphone 12, and the acceleration sensor 14.

The processor 15 may be configured to determine a first frequency response based on the first acoustic transfer path.

The processor 15 may be configured to determine the first frequency response according to a ratio of power spectral densities of the reference signal x(n) of the acceleration sensor 14 and the noise signal d(n) measured through the primary path. Here, the reference signal x(n) represents a vibration signal measured through the acceleration sensor 14, and the noise signal d(n) represents a signal collected through the microphone 12.

The processor 15 may be configured to determine an autocorrelation function of the reference signal x(n) and perform a Fourier transform on the autocorrelation are configured to determine an auto-power spectral density Sₓₓ(f) for the reference signal x(n).

Furthermore, the processor 15 may be configured to determine a cross-correlation function between the reference signal x(n) and the noise signal d(n), and perform a Fourier transform on the cross-correlation function to determine a cross-power spectral density S_{xd}(f) for the reference signal x(n) and the noise signal d(n).

The processor 15 may be configured to determine the first frequency response P(f) according to the following Equation 1 according to the ratio of the auto-power spectral density Sₓₓ(f) and the cross-power spectral density S_{xd}(f) which are described above.

$$P ( f ) = \frac{{S}_{xd} ( f )}{{S}_{xx} ( f )} \qquad [ Equation 1 ]$$

The first frequency response P(f) is expressed as a complex number and may include a first magnitude response and a first phase response.

The processor 15 may repeat the process of determining the first frequency response for all combinations of the reference signals of the acceleration sensors 14 and the microphones 12. For example, 12 reference signals may be generated based on three-axis vibration signals measured from four acceleration sensors 14, and eight noise signals may be generated from eight speakers 13. The processor 15 may be configured to determine a total of 96 first frequency responses based on combinations of 12 reference signals and eight noise signals.

Furthermore, the processor 15 may be configured to determine 96 first normal frequency responses and store the 96 first normal frequency responses in the memory 16 in the state where the speakers 13, the microphones 12, and the acceleration sensors 14 normally operate. For example, the first normal frequency responses may be determined and stored in the memory 16 in manufacturing and assembly processes before the vehicle is mass-produced.

The processor 15 may be configured to determine a second frequency response based on the second acoustic transfer path.

The processor 15 may be configured to determine the second frequency response according to a ratio of power spectral densities of a control signal u(n) of the processor 15 and a noise cancelling signal z(n) input to the microphone 12 measured through the secondary path. Here, the control signal u(n) refers to a signal transmitted from the processor 15 to the speaker 13, and the output signal z(n) refers to a signal recorded in the microphone 12 after the noise cancelling signal output through the speaker 13 passes through the second acoustic transfer path.

The processor 15 may be configured to determine an autocorrelation function of the control signal u(n) and perform a Fourier transform on the autocorrelation function to determine an auto-power spectral density Sᵤᵤ(f) for the control signal u(n).

Furthermore, the processor 15 may be configured to determine a cross-correlation function between the control signal u(n) and the output signal z(n), and perform a Fourier transform on the cross-correlation function to determine a cross-power spectral density S_{uz}(f) for the control signal u(n) and the output signal z(n).

The processor 15 may be configured to determine the second frequency response S(f) according to the following Equation 2 according to the ratio of the auto-power spectral density Sᵤᵤ(f) and the cross-power spectral density S_{uz}(f) which are described above.

$$S ( f ) = \frac{{S}_{uy} ( f )}{{S}_{uu} ( f )} \qquad [ Equation 2 ]$$

The second frequency response S(f) is expressed as a complex number and may include a second magnitude response and a second phase response.

The processor 15 may repeat the process of determining the second frequency response for all combinations of the speakers 13 and the microphones 12. For example, five control signals may be generated according to the control signal of the processor 15 input to five speakers 13, and eight output signals may be generated from eight speakers 13. The processor 15 may be configured to determine a total of 40 second frequency responses according to combinations of five control signals and eight output signals.

Furthermore, the processor 15 may be configured to determine 40 second normal frequency responses and store the 40 second normal frequency responses in the memory 16 in the state where the speakers 13, the microphones 12, and the acceleration sensors 14 normally operate. For example, the second normal frequency responses may be determined and stored in the memory 16 in manufacturing and assembly processes before the vehicle is mass-produced.

The processor 15 may compare the determined frequency responses with the normal frequency responses stored in the memory 16 and determine whether the speakers 13, the microphones 12, and the acceleration sensors 14 are abnormal. In the following, the determined frequency response is used in the same meaning as the current frequency response.

The processor 15 may compare a magnitude and a phase of the normal frequency response with a magnitude and a phase of the frequency response, respectively, within a preset frequency range and determine a magnitude difference value and a phase difference value.

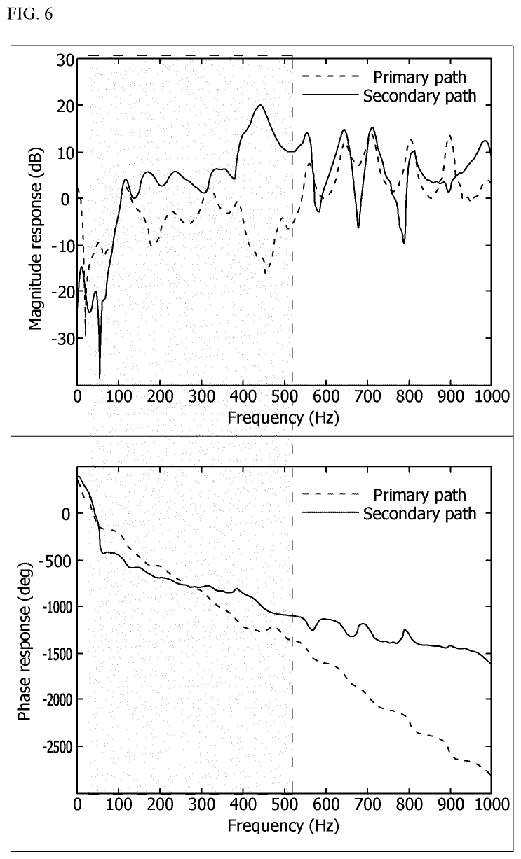

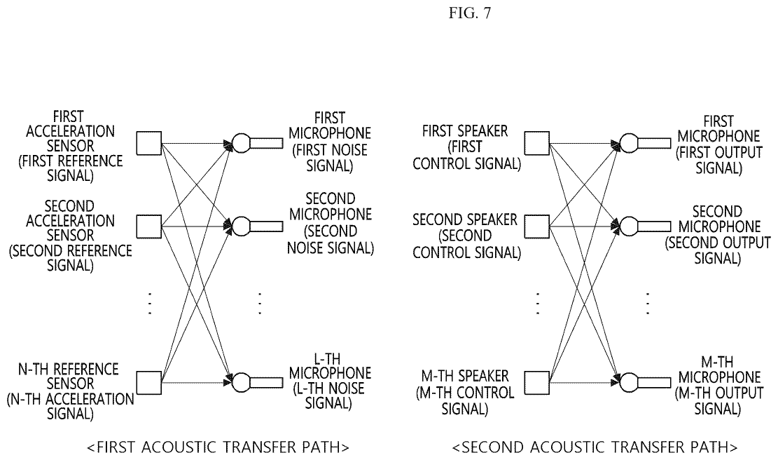

FIG. 6 and FIG. 7 are views for describing the operation of determine whether the processor is abnormal according to the exemplary embodiment of the present disclosure.

Referring to FIG. 6 and FIG. 7 together, the processor 15 may analyze a magnitude response and a phase response of a specific frequency band used for noise removal. For example, the processor 15 may analyze the magnitude response and the phase response of a frequency band of 20 to 500 Hz, but is not limited thereto, and may set the frequency band according to various conditions such as vehicle specifications, driving environments, noise levels, or the like.

The processor 15 may compare the magnitude and the phase of the currently determined frequency response with the magnitude and the phase of the normal frequency response. The normal frequency response has a constant response characteristic, and the processor 15 may be configured to determine the degree of change in the current frequency response based on the constant response characteristic.

The processor 15 may use a statistical approach to evaluate an overall pattern of a difference between the normal frequency response and the current frequency response. That is, the processor 15 may be configured to determine that the corresponding acoustic transfer path is in the normal state when the difference between the normal frequency response and the current frequency response is small.

The processor 15 may be configured to determine that there is an abnormality in the corresponding acoustic transfer path when the difference between the normal frequency response and the current frequency response significantly changes beyond an allowable limit.

The processor 15 may be configured to determine the difference between the normal frequency response and the current frequency response at a specific frequency. Here, the difference between the normal frequency response and the current frequency response may include a difference in the magnitude response and a difference in the phase response. Furthermore, the specific frequency may refer to a sampled frequency within a preset frequency range.

The processor 15 may be configured to determine a variance for the difference value of the frequency response determined within the preset frequency range. When the acoustic transfer path is normal, the normal frequency response and the current frequency response are almost identical, so that the variance may be determined as 0.

However, when there is an abnormality in the acoustic transfer path, the variance may have a positive value, and as the variance value is higher, it may be determined that a more serious abnormal state has occurred in the acoustic transfer path. That is, as the degree of the mismatch between the normal frequency response and the current frequency response is greater, the variance may be determined to be greater.

The processor 15 may compare the determined variance with a reference range and determine whether the acoustic transfer path is abnormal. The processor 15 may be configured to determine that there is an abnormality in the acoustic transfer path when a variance of the magnitude difference value and a variance of the phase difference value are each outside a preset reference range.

The processor 15 may compare the first frequency response with the first normal frequency response and determine whether the acceleration sensor 14 and the microphone 12 are abnormal.

Alternatively, the processor 15 may compare a plurality of first frequency responses according to the plurality of first acoustic transfer paths with the corresponding first normal frequency responses, and determine whether each of the microphones 12 and the plurality of acceleration sensors 14 is abnormal according to a comparison result.

Alternatively, the processor 15 may compare the second frequency response with the second normal frequency response and determine whether the speaker 13 and the microphone 12 are abnormal.

Alternatively, the processor 15 may compare a plurality of second frequency responses according to the plurality of second acoustic transfer paths with the corresponding second normal frequency responses, and determine whether each of the microphones 12 and the plurality of speakers 13 is abnormal according to a comparison result.

In FIG. 7, the processor 15 may be configured to determine K×L first frequency responses using the first reference signal to the K-th (K=3N) reference signal generated in the first acceleration sensor 14 to the N-th acceleration sensor 14 and the first noise signal to the N-th noise signal generated from the first microphone 12 to the L-th microphone 12. Here, N, K, and L are all natural numbers.

Furthermore, the processor 15 may be configured to determine M×L second frequency responses using the first control signal to the M-th control signal input to the first speaker 13 to the M-th speaker 13 and the first output signal to the N-th output signal generated in the first microphone 12 to the L-th microphone 12. Here, M and L are both natural numbers.

The processor 15 may compare the K×L first frequency responses with the normal frequency responses stored in the memory 16, respectively, and may be configured to determine that there is an abnormality in the corresponding first acoustic transfer path when the variance of the magnitude difference value and the variance of the phase difference value are each outside the preset reference range.

For example, when the variance of the magnitude difference value and the variance of the phase difference value between the first frequency response determined using the first reference signal and the corresponding normal frequency response are each outside the preset reference range, the processor 15 may be configured to determine that there is an abnormality in the first acoustic transfer path including the first acceleration sensor 14. In the instant case, when the first frequency responses determined using the reference signals of the second acceleration sensor 14 to the N-th acceleration sensor 14 are all normal, the processor 15 may be configured to determine that there is an abnormality in the first acceleration sensor 14.

Alternatively, when the variance of the magnitude difference value and the variance of the phase difference value between the first frequency response determined using the first noise signal and the corresponding normal frequency response are each outside the preset reference range, the processor 15 may be configured to determine that there is an abnormality in the first acoustic transfer path including the first microphone 12. In the instant case, when the first frequency responses determined using the noise signals of the second microphone 12 to the L-th microphone 12 are all normal, the processor 15 may be configured to determine that there is an abnormality in the first microphone 12.

Alternatively, when the variance of the magnitude difference value and the variance of the phase difference value between the first frequency response determined using the first reference signal and the first noise signal and the corresponding normal frequency response are outside the preset reference range, the processor 15 may be configured to determine that there is an abnormality in the first acoustic transfer path including the first acceleration sensor 14 and the first microphone 12. In the instant case, when the first frequency responses determined using other reference signals and noise signals are all normal, the processor 15 may be configured to determine that there is an abnormality in the first acceleration sensor 14 and the first microphone 12.

Furthermore, the processor 15 may compare the M×L second frequency responses with the normal frequency responses stored in the memory 16, respectively, and may be configured to determine that there is an abnormality in the corresponding second acoustic transfer path when the variance of the magnitude difference value and the variance of the phase difference value are each outside the preset reference range.

For example, when the variance of the magnitude difference value and the variance of the phase difference value between the second frequency response determined using the first control signal and the corresponding normal frequency response are each outside the preset reference range, the processor 15 may be configured to determine that there is an abnormality in the second acoustic transfer path including the first speaker 13. In the instant case, when the second frequency responses determined using the control signals of the second speaker 13 to the M-th speaker 13 are all normal, the processor 15 may be configured to determine that there is an abnormality in the first speaker 13.

Alternatively, when the variance of the magnitude difference value and the variance of the phase difference value between the second frequency response determined using the first output signal and the corresponding normal frequency response are each outside the preset reference range, the processor 15 may be configured to determine that there is an abnormality in the second acoustic transfer path including the first microphone 12. In the instant case, when the second frequency responses determined using the noise signals of the second microphone 12 to the L-th microphone 12 are all normal, the processor 15 may be configured to determine that there is an abnormality in the second microphone 12.

Alternatively, when the variance of the magnitude difference value and the variance of the phase difference value between the second frequency response determined using the first control signal and the first output signal and the corresponding normal frequency response are outside the preset reference range, the processor 15 may be configured to determine that there is an abnormality in the second acoustic transfer path including the first speaker 13 and the first microphone 12. In the instant case, when the second frequency responses determined using other control signals and output signals are all normal, the processor 15 may be configured to determine that there is an abnormality in the first speaker 13 and the first microphone 12.

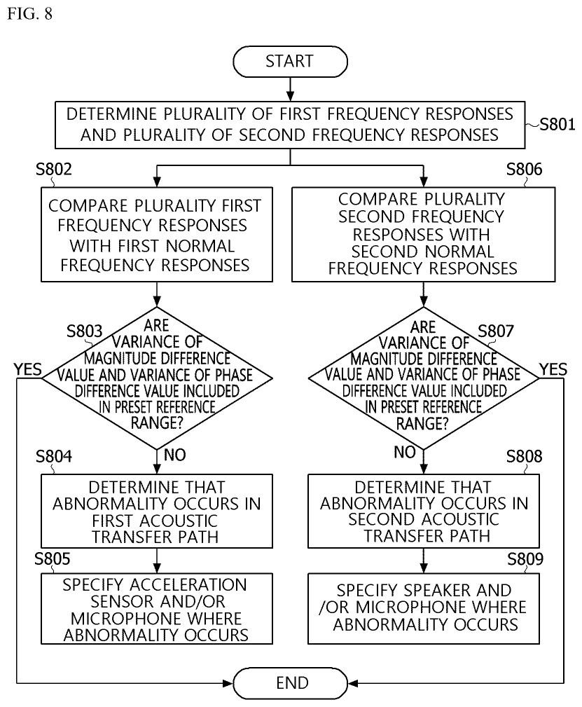

FIG. 8 is a flowchart of an acoustic control method of a vehicle according to an exemplary embodiment of the present disclosure. In FIG. 8, a plurality of first normal frequency responses are determined in advance and stored in the memory in a state where the speaker, the microphone, and the acceleration sensor normally operate. Furthermore, a plurality of second normal frequency responses are determined in advance and stored in the memory in the state where the speaker, the microphone, and the acceleration sensor normally operate.

Referring to FIG. 8, the processor is configured to determine a frequency response based on an acoustic transfer path between the speaker, the microphone, and the acceleration sensor of the vehicle. In the instant case, the processor is configured to determine a plurality of first frequency responses according to a plurality of first acoustic transfer paths, and may be configured to determine a plurality of second frequency responses according to a plurality of second acoustic transfer paths, respectively (S801).

Next, the processor may compare the determined current frequency responses with the normal frequency responses stored in the memory.

The processor may compare the plurality of first frequency responses with a corresponding first normal frequency response, respectively (S802).

Next, the processor is configured to determine whether the acoustic transfer path is abnormal according to a result of comparing the determined frequency response with the normal frequency response.

In the instant case, the processor may compare the plurality of first frequency responses with the normal frequency responses stored in the memory, respectively, and may be configured to determine that there is an abnormality in the first acoustic transfer path corresponding to the first frequency response when a variance of a magnitude difference value and a variance of a phase difference value are each outside a preset reference range (S803 and S804).

Furthermore, the processor may identify an acceleration sensor and a microphone that form the first acoustic transfer path where there is an abnormality to specify a device that has caused the abnormality (S805).

Furthermore, the processor may compare the plurality of second frequency responses with corresponding second normal frequency responses, respectively (S806).

Furthermore, the processor may compare the plurality of second frequency responses with the normal frequency responses stored in the memory, respectively, and may be configured to determine that there is an abnormality in the second acoustic transfer path corresponding to the second frequency response when the variance of the magnitude difference value and the variance of the phase difference value are each outside the preset reference range (S807 and S808).

Furthermore, the processor may identify a speaker and a microphone that form the second acoustic transfer path where there is an abnormality and specify a device that has caused the abnormality (S809).

The term “~unit” used in an exemplary embodiment of the present disclosure refers to software components or hardware components such as a field-programmable gate array (FPGA) or an application specific integrated circuit (ASIC), and “~unit” is configured to perform certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “~unit” may be combined into smaller numbers of components and “~units,” or may be further divided into additional components and “~units.” Furthermore, the components and “~units” may be implemented to reproduce one or more CPUs in a device or a security multimedia card.

With an acoustic control device and method of a vehicle according to an exemplary embodiment of the present disclosure, it is possible to rapidly and accurately determine the cause of a failure of a road noise reduction system.

Furthermore, it is possible to significantly improve the maintenance efficiency of a road noise reduction system.

Furthermore, it is possible to perform more systematically and accurately quality control by identifying the cause of a failure.

In the present way, it is possible to increase the reliability of the road noise reduction system and prevent quality problems in a manufacturing process in advance.

Although the exemplary embodiments of the present disclosure have been described above, it is understood that those skilled in the art may make various changes and modifications to the present disclosure without departing from the spirit and scope of the present disclosure set forth in the claims below.

What is claimed is:

1. An acoustic control device of a vehicle, the acoustic control device comprising:
a memory;
a processor operatively connected to the memory and configured to generate a noise cancelling signal for removing noise generated inside the vehicle;
a speaker disposed inside the vehicle and outputting the noise cancelling signal according to control of the processor;
a microphone disposed inside the vehicle to detect a sound wave signal; and
an acceleration sensor disposed in the vehicle to measure a vibration signal,
wherein the processor determines a frequency response based on an acoustic transfer path between the speaker, the microphone, and the acceleration sensor, and compares the determined frequency response with a normal frequency response stored in the memory and determines whether the acoustic transfer path is abnormal according to a result of comparing the determined frequency response with the normal frequency response.

2. The acoustic control device of claim 1, wherein the memory stores a first normal frequency response determined based on a first acoustic transfer path between the acceleration sensor and the microphone and a second normal frequency response determined based on a second acoustic transfer path between the speaker and the microphone in a state where the speaker, the microphone, and the acceleration sensor normally operate.

3. The acoustic control device of claim 2, wherein the processor determines a first frequency response based on the first acoustic transfer path, and compares the first frequency response with the first normal frequency response and determines whether the acceleration sensor and the microphone are abnormal according to a result of comparing the determined first frequency response with the first normal frequency response.

4. The acoustic control device of claim 2, wherein the memory stores a plurality of first normal frequency responses according to a plurality of first acoustic transfer paths formed by one-to-one matching of a plurality of microphones and a plurality of acceleration sensors.

5. The acoustic control device of claim 4, wherein the processor determines a plurality of first frequency responses according to the plurality of first acoustic transfer paths and compares the plurality of first frequency responses with the corresponding first normal frequency responses, and determines whether each of the microphones and the plurality of acceleration sensors is abnormal according to a result of comparing the determined first frequency responses with the first normal frequency responses.

6. The acoustic control device of claim 2, wherein the processor determines a second frequency response based on the second acoustic transfer path, and compares the second frequency response with the second normal frequency response and determines whether the speaker and the microphone are abnormal according to a result of comparing the determined second frequency response with the second normal frequency response.

7. The acoustic control device of claim 2, wherein the memory stores a plurality of second normal frequency responses according to a plurality of second acoustic transfer paths formed by one-to-one matching of a plurality of microphones and a plurality of speakers.

8. The acoustic control device of claim 7, wherein the processor determines a plurality of second frequency responses according to the plurality of second acoustic transfer paths and compares the plurality of second frequency responses with the corresponding second normal frequency responses, and determines whether each of the microphones and the plurality of speakers is abnormal according to a result of comparing the determined second frequency responses with the second normal frequency responses.

9. The acoustic control device of claim 1, wherein the processor compares a magnitude and a phase of the normal frequency response with a magnitude and a phase of the frequency response, respectively, within a preset frequency range and determines a magnitude difference value and a phase difference value.

10. The acoustic control device of claim 9, wherein the processor concludes that there is an abnormality in the acoustic transfer path based on a variance of the magnitude difference value and a variance of the phase difference value are each outside a preset reference range.

11. An acoustic control method of a vehicle that is performed by a computing device including one or more processors and a memory storing one or more programs executed by the one or more processors, the acoustic control method comprising:
determining, by the one or more processors, a frequency response based on an acoustic transfer path between a speaker, a microphone, and an acceleration sensor of the vehicle;
comparing, by the one or more processors, the determined frequency response with a normal frequency response stored in the memory; and
determining, by the one or more processors, whether the acoustic transfer path is abnormal according to a result of comparing the determined frequency response with the normal frequency response.

12. The acoustic control method of claim 11, further including:
storing, by the memory, a first normal frequency response determined based on a first acoustic transfer path between the acceleration sensor and the microphone and a second normal frequency response determined based on a second acoustic transfer path between the speaker and the microphone in a state where the speaker, the microphone, and the acceleration sensor normally operate.

13. The acoustic control method of claim 12, wherein the determining of whether the acoustic transfer path is abnormal includes:
determining a first frequency response based on the first acoustic transfer path; and
comparing the first frequency response with the first normal frequency response and determining whether the acceleration sensor and the microphone are abnormal according to a result of comparing the determined first frequency response with the first normal frequency response.

14. The acoustic control method of claim 12, further including:
storing, by the memory, a plurality of first normal frequency responses according to a plurality of first acoustic transfer paths formed by one-to-one matching of a plurality of microphones and a plurality of acceleration sensors.

15. The acoustic control method of claim 14, wherein the determining of whether the acoustic transfer path is abnormal includes:
determining a plurality of first frequency responses according to the plurality of first acoustic transfer paths and comparing the plurality of first frequency responses with the corresponding first normal frequency responses; and
determining whether each of the microphones and the plurality of acceleration sensors is abnormal according to a result of comparing the determined first frequency responses with the first normal frequency responses.

16. The acoustic control method of claim 12, wherein the determining of whether the acoustic transfer path is abnormal includes:
determining a second frequency response based on the second acoustic transfer path; and
comparing the second frequency response with the second normal frequency response and determining whether the speaker and the microphone are abnormal according to a result of comparing the determined second frequency response with the second normal frequency response.

17. The acoustic control method of claim 12, further including:
storing, by the memory, a plurality of second normal frequency responses according to a plurality of second acoustic transfer paths formed by one-to-one matching of a plurality of microphones and a plurality of speakers.

18. The acoustic control method of claim 17, wherein the determining of whether the acoustic transfer path is abnormal includes:
determining a plurality of second frequency responses according to the plurality of second acoustic transfer paths and comparing the plurality of second frequency responses with the corresponding second normal frequency responses; and
determining whether each of the microphones and the plurality of speakers is abnormal according to a result of comparing the determined second frequency responses with the corresponding second normal frequency responses.

19. The acoustic control method of claim 11, wherein the determining of whether the acoustic transfer path is abnormal includes comparing a magnitude and a phase of the normal frequency response with a magnitude and a phase of the determined frequency response, respectively, within a preset frequency range and determining a magnitude difference value and a phase difference value.

20. The acoustic control method of claim 19, further including:
in the determining of whether the acoustic transfer path is abnormal, determining that there is an abnormality in the acoustic transfer path based on a variance of the magnitude difference value and a variance of the phase difference value are each outside a preset reference range.
